(19) United States
(12) Patent Application Publication
(10) Pub. No.: US 2007/0252831 A1
(43) Pub. Date: Nov. 1, 2007

(54) Methods and Systems for Compositing Images

(76) Inventors: Daniel Richard James Lind, Christchurch (NZ); Janet Gail McGregor, Christchurch (NZ); Nicolas Alan Low, Victoria (AU); Roger Stephen Nesbitt, Wellington (NZ); Simon Alexnader Russell Young, Christchurch (NZ)

Correspondence Address: ABELMAN, FRAYNE & SCHWAB, 666 THIRD AVENUE, 10TH FLOOR, NEW YORK, NY, 10017, US

(21) Appl. No.: 10/587,129

(22) PCT Filed: Jan. 21, 2005
(86) PCT No.: PCT/NZ05/00005

§ 371 Date: Mar. 26, 2007

(30) Foreign Application Priority Data
Jan. 21, 2004 (NZ) 530738

(51) Int. Cl. G06T 15/00; G06F 19/00

(52) U.S. Cl. 345/419

(57) ABSTRACT

The present invention relates to a method of compositing multiple images together preferably to display a composite 3-dimensional image of a user's face combined with a new hair style for the user. The method executed by the present invention includes the steps of initially receiving a 3-dimensional image of a hair style and a 3-dimensional image of the user's face. An initial pixel from a foreground hair layer image is combined with an initial corresponding pixel of a face image and an initial corresponding pixel from a background hair layer image. This process continues to generate a composite 3-dimensional image illustrating the user's face with the hair style pictured.

### TECHNICAL FIELD

This invention relates to the compositing of images. More particularly, but not exclusively, the present invention relates to methods and systems for deriving an approximated three dimensional image for display.

### BACKGROUND ART

It can be difficult for hairstylists and persons to visualize a new or different hair style. This difficulty is due, generally, to the particular hair types and colour and head and facial features of the person considering a different hair style that all influence the appropriateness of a hair style. Further, the difficulty of being able to visualize how a hair style would look on a particular person adds to the uncertainty of how a hair style would look before a different hair style is permanently applied.

The conventional method of choosing a new hair style is to select a hair style as displayed in photographs of the hair style on a model. However, as a particular hair style can look very different on different people, or from a different angle from those chosen by the photographer or photo editor, the risk of applying an inappropriate haircut on a person is evident.

A method of displaying a hair style using a computer and associated monitor has been to photograph a model sporting a particular hair style from a variety of angles and generally from a fixed plane. This has the effect of showing a rotatable image when viewed. This method does not composite the images but merely displays the image of a single model from different angles. Another conventional method is to form a composite of a hair style photograph on the bust of a model and display the image from a few selected angles about the bust. This provides a basic impression of the hair style.

It is a non-limiting object of the invention to provide a method of compositing multiple images to form an approximation of a three dimensional image that overcomes at least some of the above mentioned problems, or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is a non-limiting object of the invention to provide a system for compositing multiple images to form an approximation of a three dimensional image that overcomes at least some of the abovementioned problems, or at least to provide the public with a useful choice.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to a first broad aspect of the invention there is provided a method of forming an approximation of a 3-dimensional image of the first object using images obtained of said first object, the method including the steps of;
obtaining a plurality of images of a first object from multiple positions about a substantially horizontal plane, and
creating foreground and background layers of the first object within said images, and
forming a 3-dimensional image of said first object from the images obtained, and
converting said 3-dimensional image into a desirable format for compositing purposes.

Preferably the first object is a hair style as prepared on a model head. Such a model head may be provided by a live subject or a mannequin for example. Alternatively the first object may be a hat or other desirable object that can be applied to a second object. The second object may be in the form of a person's head or otherwise. It is envisaged that the methods of the invention can be applied to any desirable application such as footwear, clothing or headgear or the like, or otherwise such as applied to animals or may possibly be applied to inanimate objects such as buildings, landscapes or the like.

Reference throughout this specification will also be made to the present invention being adapted to provide an approximation of a 3-dimensional image of a first, or second object, or a composite of these first and second objects. Those skilled in the art should appreciate that such a 3-dimensional image as discussed throughout this specification may be implemented by a collection of images of the object in question from varying views or perspectives, which may potentially be animated.

According to a further aspect of the present invention there is provided a method of forming an approximation of a 3-dimensional image substantially as described above, wherein background layer image content is extrapolated using a reflected copy of an opposed image.

In a further preferred embodiment a 3-dimensional image of the first object may be formed from the plurality of images obtained through ordering these images into a sequential array of adjacent views or perspectives of the first object. Those skilled in the art should also appreciate that this ordering or sequencing of adjacent images may be implemented either through images been received already sequenced, through sequencing the images immediately after receipt, or through sequencing these images to form a 3-dimensional image after foreground and background layers of the first object have been created within each obtained image.

According to a further aspect of the present invention there is provided a method of forming an approximation of a 3-dimensional image as described above wherein the creation of foreground and background layers is completed through executing the steps of;
(a) cropping the hair out of each image, and
(b) loading the cropped hair images into an alignment process, and
(c) defining foreground and background hair layers within each image.

According to yet another aspect of the present invention there is provided a method substantially as described above wherein the creation foreground and background layers is completed substantially as described above in addition to the execution of the further subsequent step of;
(d) animating said plurality of images to identify alignment consistencies between images.

According to a second broad aspect of the invention there is provided a method of obtaining multiple images of a second object for use in forming an approximation of a three dimensional image of the second object, the method including the steps of:
A. obtaining an image of a second object;
B. creating an approximate 3-dimensional image of the second object; and
C. converting the 3-dimensional image obtained into a desirable format for compositing purposes.

Preferably in step B. the image obtained is imported from a three dimensional modeling application wherein the settings for the various model surfaces are determined and set.

According to yet another aspect of the present invention there is provided a method of forming an approximation of a 3-dimensional image of a second object substantially as described above wherein the second object includes a face.

According to a third broad aspect of the invention there is provided a method of compositing multiple images to form an approximation of a three dimensional image, the method including the steps of:
a.) obtaining a 3-dimensional image of a first object converted into a desirable format from the first broad aspect of the invention in a desirable format;
b.) obtaining a 3-dimensional image of a second object in a desirable format from the second broad aspect of the invention; and
c.) combining each of the frames of the images of the first and second objects.

Preferably the compositing is carried out by at least one microprocessor means. Advantageously resultant images are transferable over the internet or over a computer network between a website host server and a personal computer connected to the host server.

According to a preferred embodiment of the present invention the resulting composite 3-dimensional image formed may be delivered to a remote user using a client software application via a computer network and a server software application.

According to a further aspect of the present invention there is provided a method of compositing multiple images substantially as described above wherein the composite 3-dimensional image required is generated by a server software application and transmitted to a remote client software application.

### BRIEF DESCRIPTION OF DRAWINGS

Further aspects of the present invention will become apparent from the ensuing description which is given by way of example only and with reference to the accompanying drawings in which:

FIGS. 1-5: show screen shots of a face shape wizard process provided in one embodiment, and

FIG. 6: shows a flow chart of processing steps for compositing multiple images to form an approximation of a three dimensional image according to one embodiment of the invention.

### BEST MODES FOR CARRYING OUT THE INVENTION

A method of obtaining multiple images of an object for use in forming an approximation of a three dimensional (3D) image according to one embodiment of the invention, is now described. Non-limiting variants of the process, and optional features will also be described.

The methods and systems of the invention can advantageously be applied to a variety of objects such as matching hats to heads, glasses to faces, hair styles to heads, or clothes on a person or otherwise, and in this non-limiting embodiment, and for clarity with the description, the first object will be described with reference to a hair style image and the second object will be described with reference to a face model or head model.

The imaging and compositing aspects of the invention involve use of a digital processing means in the form of a microprocessor means. The microprocessor means may be a computer server hosting the computer software configured and arranged to carrying out the methods of the invention and/or include a personal computer for a client user that has access to the computer server over a network or the internet wherein the computer server is a website host server.

Furthermore those skilled in the art should also appreciate the use of terms computer network, server software application and client software application are well known to those in the art and embody many different and varied computer software applications which can employ a multitude of communication protocols, such as, but not being limited to TCP/IP.

Reference throughout this specification will also be to user of the present invention being employed by a user. It is envisioned that a user may be a person to which the second object (or preferably a head and face) belongs to, where this user wishes to consider their visual appearance with a new hair style. Such users may employ client software applications to connect to a server software application using a well known internet connection technology. Through the methods of the present invention the server software application may facilitate the generation of a 3-dimensional image picturing the user with a new hair style.

Those skilled in the art should also appreciate that the computer system employed by a user may have many physical implementations. For example, in some instances a home computer or PC may be employed by a user, whereas in another instances a smart phone, PDA or other equivalent portable electronic device may be employed by users in the execution of methods of the present invention. Furthermore those skilled in the art should appreciate that a computer system employed by a user implemented as a cellular phone may include both smart phones with reasonable degree of processing power though to standard or more basic models with limiting processing power but with the ability to handle multimedia format messaging protocols.

Images are readily prepared in digital form and converted into desirable formats for processing according to an aspect of the invention. The first set of images that can be acquired relate to a particular hair style chosen to be applied to a face model or head model.

The images are captured and converted to a digital format for processing in accordance with the first aspect of the invention. The images can be obtained by photographing the hair style as applied to an actual human model or as detailed on a mannequin head.

Reference throughout this specification also in the main be made to the 3-dimensional image generated of a hair style including two layers only, being the foreground layer and the background layer. However it should be readily apparent to those skilled in the art that a plurality of layers may be integrated within such a 3-dimensional image. Those skilled in the art should appreciate that reference to foreground and background layers only throughout this specification has been made for the sake of clarity only.

Capturing images of the particular hair style can be obtained using the following methods:
a.) Placement of the head model in the center of a rotatable platform with a relatively static camera.
b.) Placement of the head model in a fixed or static position relative to a camera that rotates about the head model.
c.) Placement of the head model in the center of a rotatable platform or in a fixed or static position with a plurality of static cameras positioned about the head model.
a.) Placement of the head model in the center of a rotatable platform with a relatively static camera

It is envisaged in this arrangement that a turntable may be configured and arranged with an optical, electromagnetic or physical shutter trigger means mounted or marked at predetermined points about the head model so that as the head model with a particular hair style rotates, the frame images captured according to step a. in the first aspect of the invention will be obtained and used for compositing purposes.
b.) Placement of the head model in a fixed or static position relative to a camera that rotates about the head model.

It is envisaged in this arrangement that a camera is configured and arranged to rotate about the head model. The camera can be triggered by any desirable means such as, for example, optically, electromagnetically or directly, at each angle that an image for the three dimensional approximation is required.

The trigger could be activated at the pivot point or at points on the track or at various points along a circumference about the head model.

It is envisaged that a suitable backdrop using a chroma-key screen may be provided in the set up when images are being captured. This can provide an easier image to crop during the post-photography phase of the process. The screen can either rotate behind the head model and such rotation can be synchronized with the camera rotation, or multiple surfaces can be arranged forming a cylindrical screen positioned such that it is in the background of each image captured.
c.) Placement of the head model in the center of a rotatable platform or in a fixed or static position with a plurality of static cameras positioned about the head model.

It is envisaged in this arrangement that a plurality of static cameras can be configured and arranged to either rotate about the head model. Alternatively, both the head model and the cameras can be static with respect to each other. Each camera may be preferably masked by being aligned on the opposite side of the head model from an opposing camera, resulting in the model's head masking the opposing camera. Alternatively, masking can be achieved by not having directly opposing angles such that the opposing camera is neither behind the head of the head model, nor in the shot such that it comprises a clear head to background boundary. The cameras may advantageously be provided with a synchronized shutter release which assists with alignment in that the head model is in the exact same position in all shots, although this may increase the complexity to the lighting setup.

If the head model is rotating then it is envisaged that multiple angles for images can be captured with each camera.

The camera can be triggered by any desirable means such as, for example, optically, electromagnetically or directly, at each angle that an image for the three dimensional approximation is required.

It is envisaged that employing the above methods of obtaining a plurality of images will result in readily obtaining images that when displayed sequentially, produce the effect of a rotating head model at a constant rotational speed.

It is envisaged that if a non constantly rotating head model is desired the speed of rotation of the camera(s) and/or the rotatable head model can be varied, and changes to the lighting, depth of field, centre of rotation and other such aspects can be adjusted as required.

It is considered that the three steps a.) to c.) utilise one or more cameras at a constant height, approximately the same as that of the head model. This technique allows for the final approximated three dimensional image to rotate about the y axis pole. However, it is also envisaged that a plurality of cameras can be configured and arranged along a y-axis in steps a.) and b.) to allow for the final resultant image to be rotated about a centre point rather than a single pole. To achieve this technique the cameras should be in an arc with a z variance such that the distance form the camera to the model head is equal for all the cameras. Failure to incorporate this technique will result in the image appearing to zoom in and out as the output approximated three dimensional image is rotated in the y direction, unless the input images are scaled appropriately as a processing step. The same techniques may be used in each radius of the plurality of cameras in step c.). This approach allows for a final output approximated three dimensional image that can be rotated in any direction about its centroid.

It is envisaged that at least one video camera can be used as the recording device. If a constant speed platform is used then the video frame rate means that a constant proportion of the frames can be selected and used as still frames in order to generate a constant speed rotation.

It is further envisaged that by using a turntable of constant speed or by arranging the camera(s) to move at a constant speed, as in method b.), the shutter action can be activated by a timer means rather than using a trigger means. Alternatively it is considered that a known non-constant speed could be used with a function employed to determine a non-constant trigger rate, but such an arrangement can increase the operating complexity of the process.

It is considered that the lighting equipment used during image capturing should be placed so as not to overlap with the hair/face boundary. If a rotating camera is used with static lighting then the head model should be lit from multiple directions and the rotating camera(s) and associated rig should not cast a shadow on the facing side of the model or cause a shadow to overlap the cropping boundary. One technique for achieving sufficient lighting of the head model during image capturing is to support lighting devices and systems with ceiling mounts so that the lighting stands are not in shot and there is flexibility and freedom of movement of a camera tracking arm where used.

One aspect of the set up of the head model relative to the camera(s) is that the head model should be aligned with respect to the camera and the final approximated three dimensional head model sporting the hair style. If the head model on the platform, or the arm or the track, is not centered on the centre of the head model then the frames of the hair style or the head model may well need to be scaled to achieve more accurate and more desirable compositing of the images. Further, if the head model is not photographed at the same angles as the face is rendered then the hair will not align to the head model. If the hairline of the model is not in the same position in the shot then the hair must be translated such that it aligns with that of the face model. If the degrees of rotation of the hair photography are not known then it is far more difficult to align the face model with the hair frame for the composite.

If the head model is tilted forward or backward or is leaning to one side then unless the deviation is of a known quantity and the angle is desirable in the end images then it may not accurately composite on the face model and can significantly increase the time taken to complete the manual alignment steps.

To achieve alignment of the head model to the camera and other composite components the following methods can be used:
a) laser align the camera with the head model.
b) laser align the centre of rotation from three directions.
c) hold head model in position with chin rest/bite-bar.
d) mercury switch/gyroscopic alignment.
e) platform mounted armrest/stool.
   a) Laser Align Camera with Head Model.

Attach a laser to the camera and align it so that the beam is in the centre of the head model's face at 0 and 90 degrees. Alternatively, use two lasers at the end of two arms (x-axis displacement) and then angle them in so that they cross at the centre point in the x, y and z axis.

b) Laser Align the Centre of Rotation from Three Directions

Use a laser mounted directly above the head model and two more at right angles on the x axis in order to visually identify the centroid of the head model. Video cameras can be used, preferably from above the head model, to make it easier for a single operator to determine whether alignment is being maintained.

c) Hold Head in Position with a Chin Rest or Bite Bar

A chin rest or bite-bar can be mounted to the head model's torso or shoulders, holding their heads in position with respect to their bodies. A key requirement is that none of the brace overlaps the hair/background boundary in any angle of the shot.

d) Mercury Switch/Gyroscopic Alignment

Mercury tubes or gyroscopes can be attached to a circuit to identify when the head model (visual or auditory signal) has deviated from straight and level. The switches or gyroscopes must not interfere with the hair being photographed and therefore may be best mounted on the chin, mouth or cheek.

e) Armrest or Stool

Using a tripod armrest or other standing support railing may reduce head movement as compared to unaided standing. If a seated model is used then preferably a stool is used as it should not affect the drop of longer hair in the rear angles.

Furthermore, those skilled in the art should also appreciate that the techniques discussed above may also be used in some alternative embodiments to obtained a plurality of images of a second object from multiple positions about a substantially fixed horizontal plane in accordance with a second aspect of the invention.

The next step in the method of obtaining multiple images of the first object in the form of a hair style is with cropping the hair as photographed, away from the model's face.

The three main areas in the photographic setup that enables efficient cropping are:
a) Correct head model alignment.
b) Hair to clothing contrast.
c) Hair to skin contrast.

Correct head model alignment can be considered important and has already been described. The hair to clothing contrast can be effected by having the model wear a matte white wrinkle-free garment with a high tight smooth collar. Hair to skin contrast can be heightened by having the model wear makeup at the hair-face border (bearing in mind that this border can be the nose in profile shots, for example). It is also useful to mask the eyebrows as these are particularly difficult to crop out if they overlap with the hair edge.

The cropping process
a) Setup—select desired frames, rotate adjust colour.
b) Crop hair out of each frame.
c) Loading frames into alignment template.
d) Scale and align hair to reference heads.
e) Create foreground and background hair layers.
f) Animate frames and check for alignment and colour inconsistencies.
g) Export for conversion into custom graphics format.
   a) Setup

The individual frames can be selected from the potential candidates. They are rotated to the correct orientation if shot in portrait mode. The colour curves, contrast and the like can be standardized across the frames.

b) Hair Cropped from Each Frame

Each frame can be individually cropped using editing computer software such as, for example, Photoshop's™ Extract function or Corel's KnockOut™. Alternatively, the hair can be cropped from the face using less specialized tools, such as a standard digital masking approach with soft-edged brushes. Photoshop's history brush™ can be applied to restore any deleted sections to improve the alpha-blending.

c) Load Frames into the Alignment Template

The individual frames can be added to a single document that makes it possible to animate them and work on them all at once—such as the gross scaling. Those skilled in the art should appreciate that some form of alignment process may be employed in conjunction with the present invention to ensure consistency between adjacent or sequential images and across all images obtained. Reference to the use of alignment templates only throughout this specification and directly below should in no way be seen as limiting, as those skilled in the art should appreciate that many different mechanisms may be employed (such as formulate based transforms) to align or correspond images with each other, and reference to the above only throughout this specification should in no way be seen as limiting.

d) Scale and Align Hair to Reference Heads

The alignment template is a layered setup as used in programs such as Photoshop™ and The GIMP™ that includes reference heads that test various face-shapes and skin-tones so that the hair alignment and alpha-blending can be tested against a range of disparate face model outcomes. The reference heads have the same number of frames as the final composite. The reference heads are examples of those generated using the face model generation process described elsewhere in this document.

By locking all the layers a gross-scale of the hair can be achieved so that all the frames match. Individual frames typically can require additional scaling and translation if the hairline on the head model or head shape is unusual or the head model was not correctly aligned in the original photography. Alpha-blending often needs to be hand painted so that different skin-tones show through the hair properly.

e) Create Foreground and Background Hair Layers

This particular unique aspect of the process refereed to as step b. in the first aspect of the invention has been found to enhance the images obtained and provide an improved image. We can obtain multiple layers in the final composite so that various profiles (for example) still have unbroken hair behind them. Many layers can be derived, and for this non-limiting embodiment described, three layers are provided. They are defined as background hair, mid-ground face and foreground hair. When using live models as the source of the hair and hair style, as opposed to capturing images of a wig as applied to a mannequin or on a bust of a head model, foreground and background hair can be obtained in the same captured image.

The hair can be divided into what is foreground and background hair taking care to follow perspective lines within the hair style. The cut is typically feathered to obtain a smoother transition between the layers. This can allow, for example, foreheads in the middle layer to poke between the foreground and background layers at different points for different face shapes while using the same hair layers without the sharp edges or gaps.

Another technique we can apply for filling in any missing background hair is to use the reflected captured image from the opposite angle. In such instances the missing background hair may be extrapolated through using a reflected copy of an opposed image to the image requiring the extrapolated hair. By aligning it correctly the background hair becomes highly plausible when you consider that typically little of it is shown around the face—it can merely supplement the background hair present. The colour tinting of the donated hair can also be changed to match that of the known background hair.

Most of the hair that is photographed is in the foreground layer, so it may not need to be supplemented in this way. We have found that by using standardized naming of the layers, each layer can be automatically identified and composited correctly.

As discussed above those skilled in the art should also appreciate that multiple layers of the hair style or object in question may be integrated into such images, and reference to foreground and background layers only throughout this specification should in no way be seen as limiting.

f) Animate Frames and Check for Alignment and Colour Inconsistencies

By animating the final frames with reference heads after work is completed then they can be seen as they will be in the final product, and any “bounce” (resulting from relatively mis-scaling or mis-alignment of individual frames with respect to the others) or colour variation in individual frames becomes obvious and can be corrected.

g) Export for Conversion into Custom Graphics Format

In a preferred embodiment the images converted into a format desirable for composition may be stored with an electronic file format which stores multiple images composed of multiple layers within a single file.

The finished two layer frames can then be exported into a custom image format that can make them faster to composite. The reason for doing this is that if just-in-time compositing of the three (or more layers) is required, then standard image formats are inefficient.

For example, if 12 angles are used in the final output approximated three dimensional images, and each angle is composed of three layers: foreground hair, middle ground face and background hair, then 36 standard graphics files are required. The complete composite would require 36 open and close operations, in addition to the actual compositing into the final 12 new images. In addition to the open and close operations, the standard graphics file formats such as PNG require decompression into raw pixel data before the compositing can occur.

The format preferred in accordance with the present invention can hold decompressed raw 32-bit pixel data, and preferably may also include alpha-blending channel information, with each of the angles for a given layer held in one file. This means that the 36 open, close and decompression operations from the example given become just 3 open and close operations, without any decompression operations. While it is still processor intensive to create files in this new format (defined as the MGC file format), because they are separated into layers, the processing does not need to be done at request time, but rather can be batch processed. This means that the total request-time processing time using MGC files is about 50 times shorter than when using standard file formats on the same computer.

In a preferred embodiment a 3-dimensional image of a first object may be converted into a format desirable for compositing through being stored in an electronic file format which stores a plurality of sequential images from a common layer within a single file.

In a further preferred embodiment a file may be stored for each layer present in the 3-dimensional image obtained of the first object.

To create MGC files, we take compressed image files from each angle of an identical size with their alpha information, decompress them to raw image data and stream them to a single file with minimal header information. This step need be only performed once for each layer. In such instances a single file will then be created for each layer of the 3-dimensional image of the first object with each file consisting of a series of sequential images of the first object illustrating the content present in a particular layer.

In a preferred embodiment an alpha-blending process may be applied to a foreground layer of an image.

A few of the processes described have referred to alpha-blending. Alpha-blending is what allows transparency so that an image in a lower layer can show through to a higher layer. This can be useful to allow a face to show through from under the hair. Some graphic formats (such as GIF) can allow single pixel alpha-blending. This means that a given pixel can be either completely transparent or completely opaque. Some image formats (such as PNG and TGA) can allow for degrees of transparency for each pixel. As hair can be semi-transparent, unless you are operating at a very high resolution, single hair strands may well be more than 1 pixel in thickness (and even then, especially with very light coloured hair, you need alpha transparency for heightened realism because the colour of the hair and skin beneath needs to show through). The result is that to realistically show hair where it overlaps with a face or other background feature, the process may require an image format that can support degrees of transparency per pixel. In cases where such an image format is not applied, and when capturing images of hair styles having frizzy fringes, the edges of the hair in the images obtained can be rough and pixilated. The result is that the hair does not appear to look realistic.

However, it is seen that if an image format such as PNG or TGA is applied, the image files derived are large files. The JPEG format compresses the file and it is seen that it is a useful format for image files resulting in reasonably clear images. Further, as web-browsers can render these image files without modification it is considered a useful universal format.

Of the compressed formats readily available, the JPEG format is useful for displaying highly compressed yet high quality photographic images but unfortunately such a format does not support alpha-blending. Alternatively a custom written graphics format can be applied to the process of the invention, although it will be appreciated that complimentary display software, including a browser plug-in, is required. With this option, a user may well need to download a browser plug-in. Optionally, a software package including all the software required for the process of the invention can be downloaded and installed in the user's computer before the images are displayed. This option would increase the likelihood of the end user and the website server hosting the computer software associated with the processes of the invention to be fully compatible and can allow the user to communicate with the website host server as required.

A further option involving use of alpha-blending is to composite the hair with the face on the website host server. With this option the size of the files generated can be large. It is envisaged that a copy of the composited image can be obtained and then converted into a JPEG file (which is highly compressed but yet maintains a very high quality for hair images) before the file is downloaded to the user's computer for display. The advantage of this approach is that the quality of the final composite can be very high compared to using single-pixel alpha-blending on the client or server side, such as GIF composites and very low bandwidth (compared to using full alpha-blend supporting formats such as TGA and PNG which are not nearly as highly compressed).

We now turn to the second aspect of the invention involving a method of obtaining multiple images of a second object for use in forming an approximation of a three dimensional image of the second object, provided in this non-limiting embodiment through a face model.

Those skilled in the art should appreciate that reference to the term face model or 3-dimensional face model should be taken to mean an electronic 3-dimensional model of an object or face, normally represented through a definition of a series of points or surfaces within a 3-dimensional volume or space. Such 3-dimensional objects or models may be created for a face from the one or more images initially obtained of the second object or face.

Furthermore, in a preferred embodiment this 3-dimensional model of the second object or face may in turn be used to generate or obtain a 3-dimensional image of the second object or face through the use of a rendering software application. In such preferred embodiments these plurality of complimentary images may be arrayed in a sequential order of adjacent views or images, where these sequential array of images are complimentary to the images obtained of the first object as discussed above.

This process can involve the creation of a three dimensional face model without requiring the use and application of photographs of the new user directly in the compositing. In this process unique facial and head identifiers can be derived and applied to ensure that the face models may closely match or resemble the facial and head features of a new user who may submit photographs of their face.

An advantage of using three dimensional models of heads, rather than just photographs of the face to which the hair is to be applied is that the three dimensional head models can be setup such that the head beyond the hairline is the same size for all users. This means that the hair images can be composited onto the various head models, without having to re-scale the hair images. By scaling the hair images during the processing step to match a standardized head size, the hair images are a good fit with all of the customers face models.

According to a further aspect of the present invention such a rendering software application is used to generate a plurality of images complimentary to images obtained of a first object in accordance with the first aspect of the present invention.

Preferably images generated by such a rendering software application may be saved as at least one 3-dimensional face model image to a database.

In one non-limiting application of this method, the following steps may be applied:
a) obtaining at least one photograph, and preferably two photographs, of the face to which the hair style will be applied. The photographs can be sent over the internet to the website host server. The photographs should meet certain criteria and be in portrait mode and may include at least one profile;
b) converting the image(s) of the face as obtained into a three dimensional face model;
c) importing the image file into a suitable three dimensional modeling computer software program;
d) adjusting the three dimensional image to ensure that the material settings for the various model surfaces are set, including a high gloss finish for the eyeballs, and the texture mapping may be checked;
e) opening the image file in a renderer capable of generating images from the standpoint of a variety of x,y,z co-ordinates. Still frames can be rendered to match the angles taken in the hair photography to be used in the final composite imaging step of the process. The frames can be rendered in a format with alpha-blending capability such that there is a transparent background around the model; and
f) adding the face model images to a database.

In a preferred embodiment an approximate 3-dimensional image of the second object may include information regarding a face shape obtained from a user of the present invention.

In such embodiments face shape information may be obtained through asking a user to supply information with respect to;

(i) the position of the widest point of the face, and

(ii) whether the face is wider at the forehead of mouth, and

(iii) whether the main proportions of the face are equal or different, and

(iv) whether the jaw line is rounded, narrow or square

The process can optionally involve a face shape wizard to assist users with determining their face shape in a more objective way. There are many face shapes, and these may be categorized for convenience purposes as essentially about seven standard face shapes. It will be appreciated that face shape is generally the largest single determinant of which hair styles will suit a person. Many people have been told that they have a certain face shape, although the shape can change over time with weight gain or loss, and further, many people can have the wrong impression about their face shape.

Rather than just looking at the seven face shapes and choosing which face shape best describes a user's face, the face shape wizard breaks the process down into more objective steps that leads a user to an outcome by combining the individual elements of each step rather than simply choosing one face shape. To achieve this end a series of questions is posed to the user, as illustrated in the screenshots below, and then applying the following algorithm to derive a ranked set of choices.

A series of questions are asked and depending on each answer the various face shape outcomes are given points. Once the points have been tabulated the outcomes are ranked from highest points to lowest. The points always begin at zero and then are credited as follows:

Question 1: widest point of face?

at the forehead:
   heart +4
   square +2
   rectangular +2
at the cheekbones:
   heart +3
   square +2
   rounded +1
   rectangular +1
   pear +1
   diamond +2
   oval +3
at the jaw:
   heart +2
   square +2
   rounded +4
   rectangular +2
   pear +2
   diamond +3
   oval +3
      Question 2: face wider at forehead or mouth?
the same width at forehead and mouth:
   oval +2
   square +4
   rectangular +3
   rounded +4
   diamond +4
wider at the mouth:
   pear +4
   rounded +2
   oval +1
   square +2
   rectangular +2
   diamond +2
wider at the forehead:
   heart +4
   diamond +2
   oval +3
   square +2
   rectangular +2
   rounded +3
      Question 3: main proportions equal or different?
face about equal width and height:
   diamond +4
   rounded +4
   square +4
   oval +1
   pear +3
   heart +2
face length is greater than width:
   square +3
   rectangular +4
   oval +4
   heart +2
   diamond +3
   pear +3
      Question 4: is the jaw line—rounded, narrow or square?
rounded jaw line:
   pear +4
   heart +2
   oval +1
   square +2
   rectangular +1
   rounded +4
narrow jaw line:
   oval +3
   square +1
   rectangular +1
   heart +3
   diamond +4
square jaw line:
   diamond +2
   heart +2
   pear +1
   oval +2
   square +3
   rectangular +4

In addition, the following rules can be used to create a shortened ranked list that a user can choose from, making the choice easier and making it easier to display them. The principle behind the rules is to display options that have similar likelihood of being correct, rather than, for instance, showing the top three even though the third option may have little likelihood of being the right choice has indicated by the absolute number of points it accrued.
a) If the points difference between the outcome ranked 1^{st} and the outcome ranked 2^{nd} is greater than 2, then don't show the 2^{nd} or subsequent ranked outcomes.
b) If the points difference between the outcome ranked 1^{st} and the outcome ranked 3^{rd} is greater than 3, and the value of the 3^{rd} ranked outcome is 3 or less, then don't show the 3^{rd} or subsequent ranked outcomes.
c) If the points difference between the outcome ranked 2^{nd} and the outcome ranked 3^{rd} 4 or more and the value of the 4^{th} ranked outcome is 3 or less, then don't show the 4^{th} or subsequent ranked outcomes.
d) Don't show the 5^{th} or subsequent ranked outcomes.
e) If two face shapes have the same score then they are distributed down through the rankings and then assessed by the above rules, i.e. if there are two outcomes ranked is a 2^{nd}=then one is arbitrarily re-ranked 2^{nd} and the other is re-ranked as 3^{rd}.

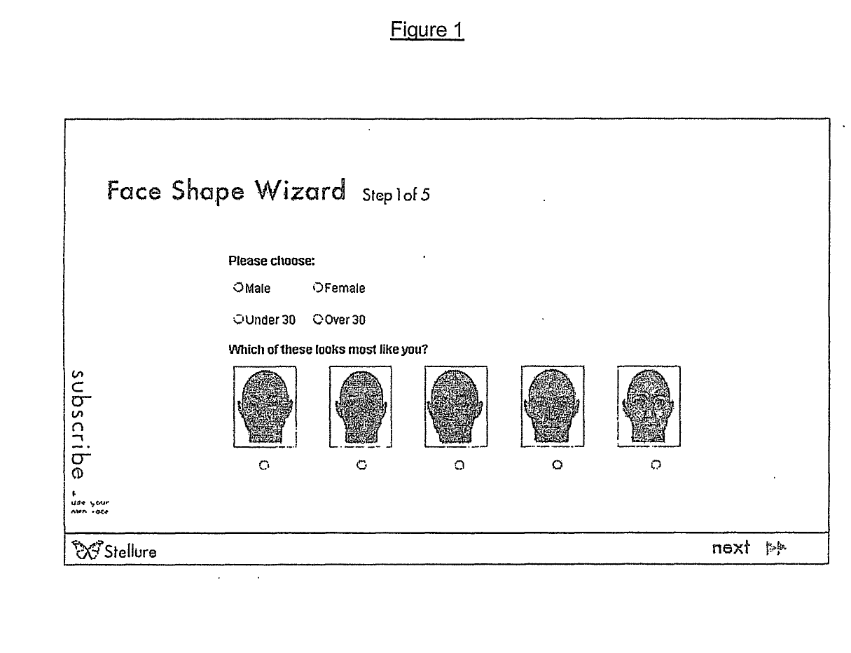

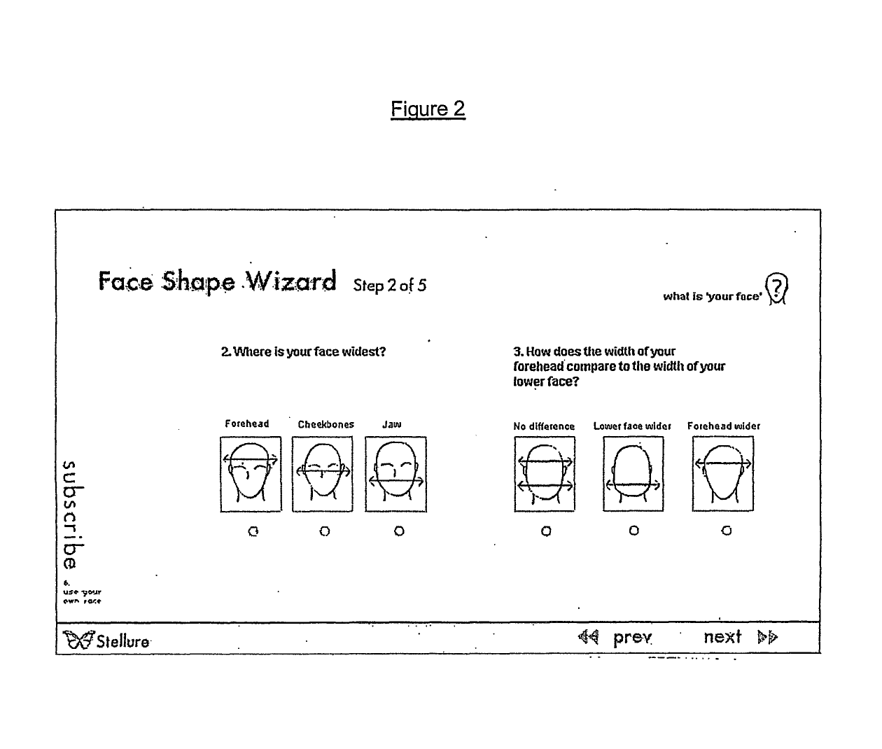

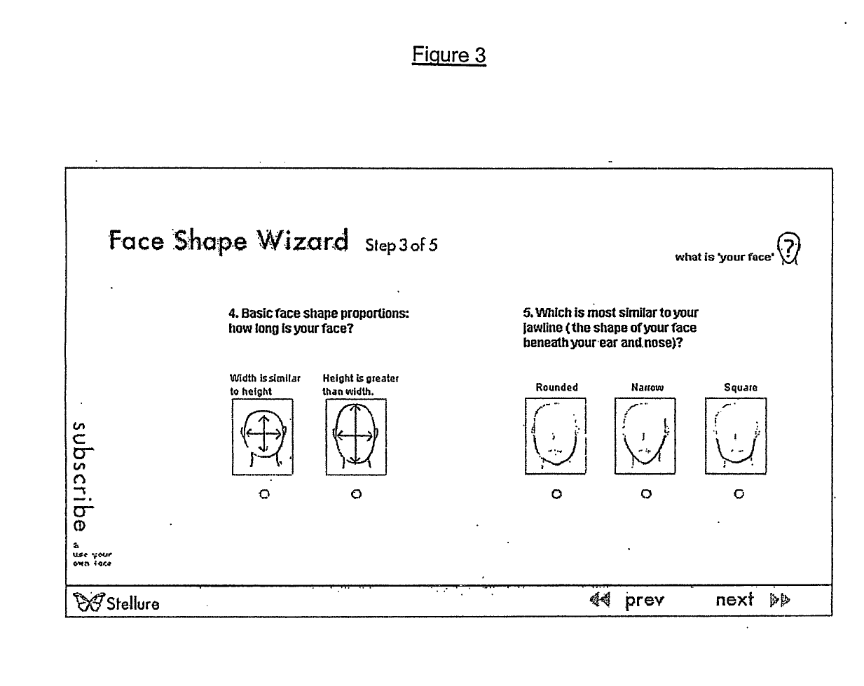

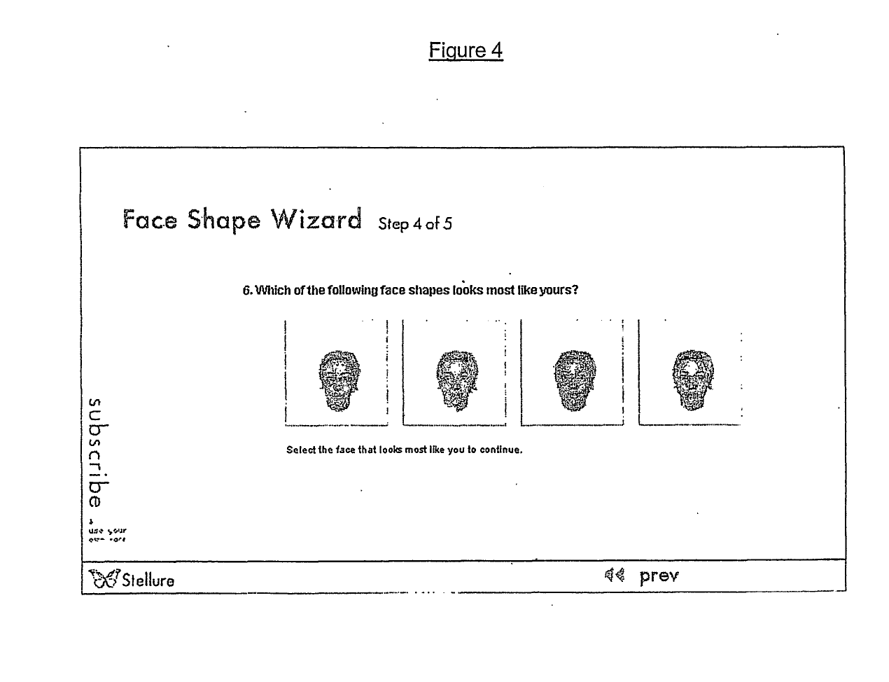

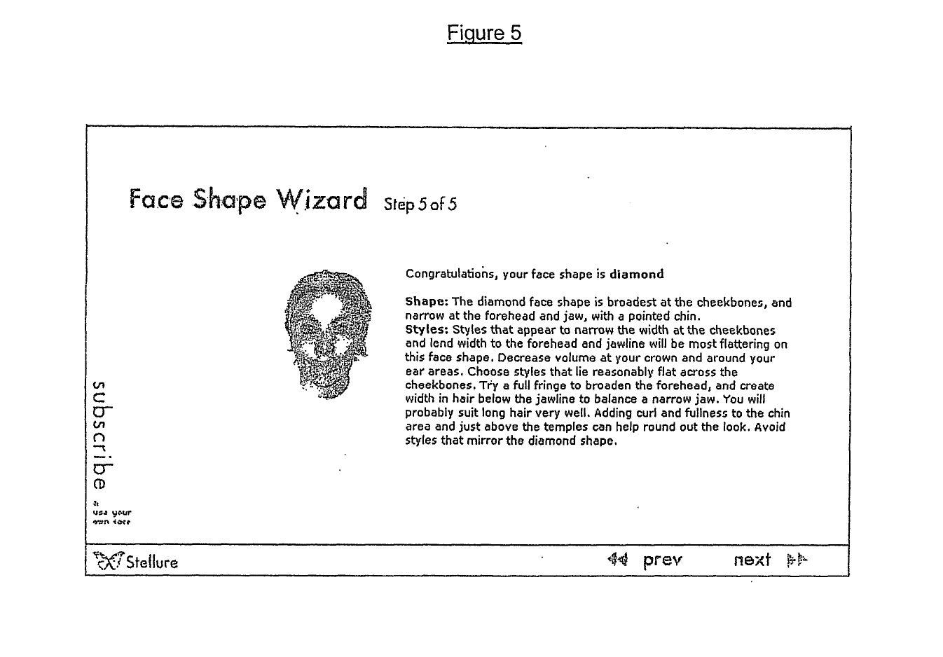

Screenshots of a computer system's display used to implement this face shape wizard are shown as FIGS. 1 through 5.

For purposes of this face shape wizard program the resultant “face shape” is defined as the outline of your face when viewed from the front and up to your hairline. The reason for this is that some people think about their fringe as the borderline between hair and face which can give the wrong impression, or a user can consider the width of their face as being between their ears rather than between their cheekbones.

However, in an alternative embodiment of the present invention an alternative scheme may be employed to generate or obtain multiple images of the second object. For example, in such instances the second object or preferably the face and head of a user may be photographed at a properly equipped station to allow photographs to be taken from essentially the same angles and orientation as the images recorded for the first object or hair style.

For example, in such instances beauty salons, hairdressers or other similar business operators may offer such a photographic facility to allow for assisting the creation of a 3-dimensional image of the second object in a desirable format for compositing purposes. In such instances the same approach or techniques employed with respect to the generation of a plurality of converted images of the first object may be employed in relation to the second object.

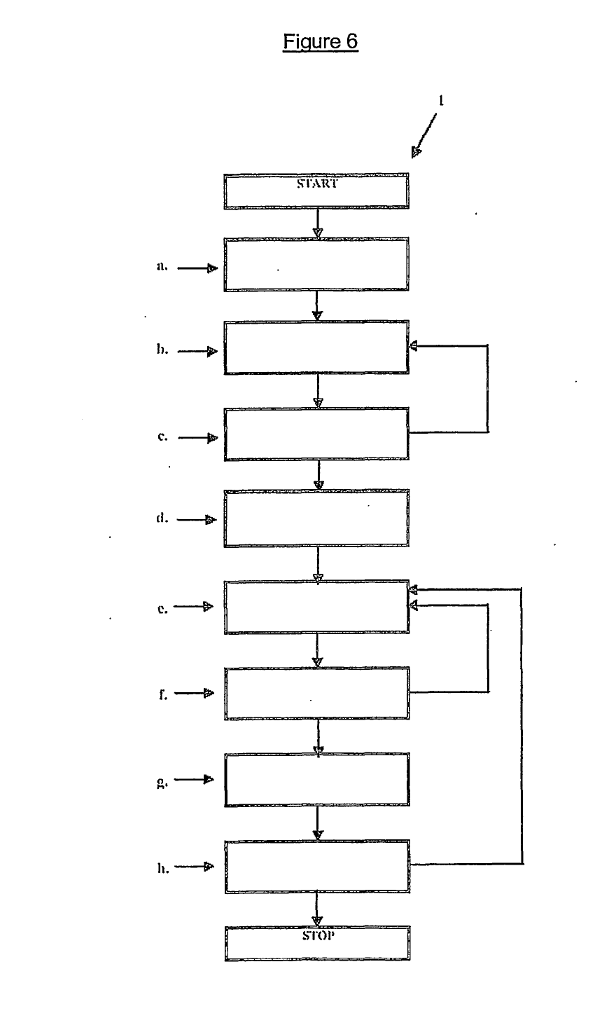

Referring now to FIG. 6, a method of compositing multiple images to form an approximation of a three dimensional image, will now be described.

The compositing process can be carried out by a number of methods as follows including:
a) Server-side hair image and face model image compositing.
b) Client-side hair image and face model image compositing.
c) Client-side composite of 3D head model and hair images.
d) Server-side composite of 3D head model and hair images.

Those skilled in the art should also appreciate that the resulting composite 3-dimensional image generated as discussed above may not necessarily be transmitted to a user of a computer network. For example, in some instances where a single station is used to generate images of a user's face, a single stand alone computer system may in turn be used to combine the corresponding pixels of the face and hair style and also to display these composite pixels to a user. With this stand alone application, a user may visit a salon, or a similar business, have their photographs taken and subsequently the composite 3-dimensional image may be generated and displayed to them illustrating how they will appear with a new hair style of interest.

The resulting server-side composites can be sent in an animated format to a user. One format may be as a Quicktime™ movie, or as single frames. One aspect of the process may desirably include returning a flash movie of a complete rotating render. A standard JPEG file includes information about how the image was compressed at the start of each image file. As the process may include compressing each frame using the same JPEG settings, that information may be included for all frames to derive a file size that is smaller than if the frames were sent individually. This can be achieved without breaking the JPEG conventions by returning a Macromedia™ Flash movie with all the frames instead of sending them individually and further, the total size of the collection of images to be transmitted is reduced.

Another alternative is to per-composite all possible combinations on the server-side rather than doing real-time compositing. The gains by not having to process at the time of the server request is reduced by the increased database search time required, and there is a very large data storage requirement. Further, the necessary batch processing of new head models can cause synchronisation issues.

a) Server-Side Hair Image and Face Model Image Compositing.

In a preferred embodiment the server software application provided may be adapted to execute the steps of;
a. retrieving a 3-dimensional image of a hair style provided in accordance with the first aspect of the present invention, and retrieving a 3-dimensional image of a face provided in accordance with the second aspect of the present invention, and
b. taking an initial pixel from the foreground hair layer image, and initial corresponding pixel from a face image, and an initial corresponding pixel form a background hair layer image and combining them, and
c. repeating step b. for subsequent pixels of the corresponding image of the hair style and the corresponding image of the face.

According to a further aspect of the present invention there is provided a method of composting multiple images substantially as described above further characterized by additional subsequent step of;
d. compressing the resultant composite image and transmitting it to a user, and
e. repeating steps b. to d. for all subsequent images of the hair style and the face.

According to yet another aspect of the present invention there is provided an alternative method of compositing multiple images substantially as described above, further characterized by execution of the alternate subsequent steps of d. and e.
d. storing the resultant composite image for compilation into an animated format, and
e. repeating steps b. through d. for all subsequent images of the hair style and the face.

According to an alternative aspect of the present invention the server software application may execute the composition steps discussed above, but may store the resultant image after the execution of step c. These resultant images may be stored for compilation into an animated format. In such instances resultant images may be stored for later animation, as opposed to immediately being compressed and transmitted to a user as discussed above.

This is a preferred method and has been described with reference to the flow chart in FIG. 6.

It is seen that steps a. to c. can be completed in batches while steps d to h can be completed at request time. The steps of the method may include:
a. uncompressing each of the images from each angle and each layer where each image has the same dimensions and correct relative alignment of the image elements from a format with alpha-channels into raw 32-bit image data;
b. combining each of the angles of the foreground hair in sequence into a single file storing all the information for it's layer (using an approach such as that of the MGC file format described earlier) and storing the resultant file in a database/data structure with a reference number;
c. repeating step b. for the background hair layer and for all the customers' mid-ground head layers;
d. when a certain hair style with a certain head model is requested, extracting the two stored hair layer files associated with the requested hair style from the database/data structure along with the requested head model mid-ground image layer;
e. taking the first pixel from the foreground hair layer image file, the first pixel from the head model mid-ground image layer file and the first pixel from the background hair layer image file and combining them and preserving the alpha channel information into the first pixel of the first of the output image series;
f. repeating step e. for all of the pixels of the first frame of the output image series;
g. compressing the resultant image and sending it to the requestor or storing the resultant image for compiling into an animated format once all of the frames are complete; and
h. repeating steps e to g for all of the frames.

One advantage of this approach is that the composite step can be fast, and single frames can be sent before the entire series is complete. If a single composite frame is requested then only the pixels in the layer files required for that angle are processed.

When a user requests a certain hair style from the database, their selected face model images are composited with the selected hair images and returned, either a frame at a time or as a multi-frame document/movie.

b) Client-Side Hair Image and Face Model Image Compositing

Images capable of alpha-channels (either separate or integral) are sent to the user or client for compositing. One advantage in the method is that the face model frames can be cached on the client side and re-used for different hair styles. This can reduce the internet traffic between client and server. However, this is offset by the fact that commonly used alpha-channel capable formats are not highly compressed.

c) Client-Side Composite of 3D Head Model and Hair Images

A 3D renderer may be used on the client side so that instead of sending images of the 3D model, the model and textures are sent and it is rendered on the client side. The renderer should be restricted to the angles that hair photographs are available for. The hair photographs are still composited in two dimensions such that only an approximation of 3D rendering of the composited image is obtained, as you are still restricted to the finite number of angles for which you have hair photographed.

d) Server-Side Composite of 3D Head Model and Hair Images.

This is similar as described in method c) above, but is done on the server side with the frames sent as in method a). One advantage of this approach is that the batch rendering of the individual face model frames is not necessary.

A further feature of the method of the invention is to provide a colour tinting step. This is a process that allows for a variety of colour tints to be applied to a hair style, and utilises a method whereby the key part of the step can be done at the time of the just-in-time composite such that all of the possible re-colourising alternatives for all of the different hair styles do not need to be stored in the database.

This method alters the hair colour by using donated colour and saturation values from hair that is the target colour and by adjusting the source hair's brightness and contrast to match that of the donor hair. The brightness and contrast adjustments are currently done manually using standard image manipulation tools, while the colour (hue) and saturation value donation can be performed automatically. Once the transformation value for each category of colour transformation, or each individual hair series if desired, is completed, the global transforms for all the pixels or the individual transforms for each pixel can be stored. The stored values then can be injected into the process so that other steps can be completed automatically.

There are two main alternative approaches with respect to the adjustment values. Either the adjustment information for each hair series is calculated and stored with it, or an average or typical set of adjustment values for a given hair shade transformation are used for all transformations in that class. The problem with storing the adjustment information for each hair style is that you have to complete it for each possible transformation—12 for even a basic set of four colours transforms. If categories are used you may only require 12 in total if a basic set of four colours is used. For each possible transformation combination we need to create adjustment values.

If the categorized approach is used, the more sub-categories of hair shade (and therefore transformation combinations) that are used the more accurate the final outcome is.

A basic set of four source and target colours could be:
(black to blonde, black to brown, black to red)
(brown to black, brown to blonde, brown to red)
(blonde to black, blonde to brown, blonde to red)
(red to black, red to brown, red to blonde)

While the solution described here can be implemented on the client-side, with our current process it is necessary to implement it on the server side. This is because our server sends composited images without alpha-channels to the client, and we only want to re-colourize the hair, not the model's face. Alternatively, this could be achieved by using the masking information stored with the cropped hair and applying the mask to the face model images, so that only the hair was colourised.

To add it into the just-in-time compositing process we need to add one or more image layers to the composite process. These additional files could be in MGC format and hold the transformation values on a pixel by pixel basis which are to be applied to the foreground and background hair files before their values are added to the outcome files at the time of the just-in-time composite request. The transformation values should be applied to each hair layer separately rather than to the whole composited image to avoid the problem of having to mask the model's face images. That is why in the process described below the transformation values are applied to each layer rather than to finished composite.

In addition to the adjustment values for each hair shade transformation target colour, we make a hair texture image. The hair texture images are created from a “donor” photograph that epitomizes the ideal outcome of the re-coloured hair. The donor hair file has the same (or larger) dimensions as the image to re-colour. The hair texture file created out of the donor hair photograph should be the same scale as the source hair, and completely filled with seamless hair imagery. To keep the scale, and yet have no blank spaces in the texture file, the donor hair photograph is mirrored along several axis within the texture file allowing for the area to be full of seamless hair of the correct scale.

To use the donor hair colour in the outcome image the donor and the source images must be in HSL (Hue, Saturation, Luminescence) mode rather than RGB (Red, Green, Blue) mode. The hue and saturation values from the donor pixels are used to replace those of the source pixels to create the outcome pixels. The source's luminescence values are retained in the outcome image.

One advantage of this approach is that rather than a single colour tinting, the full dynamic range of colour shades that are visible in normal hair can be obtained. The difference is particularly noticeable in shades of blonde hair as this type of hair has the most colour variation.

In addition to the changes to the pixels made by the hue and saturation donation, the pixels are also adjusted for brightness and contrast. These adjustment values are specific not only to the target colour, but the source colour as well, or, as noted above, they can be specific to individual source images. The values can be adjusted by altering the levels, curves or brightness and contrast values, or a combination of these. For each of these approaches different algorithms can be used. We are using existing algorithms. Whichever adjustment is made the aim is to make the brightness and contrast of the source hair colour more closely match that of the donor hair colour.

If you use “levels” or the “brightness and contrast” adjustments, the values of all the pixels in the file are examined and then the same function is applied to all the pixels in the image. If the adjustment is made using “curves” then only some pixels are altered. In the former case a formula can be stored on the server for either a specific category, or a specific image series. If a “curves” adjustment (or any other non-global transformation) then the specific transformation values for each pixel must be stored for each category or specific image series. Even if a global formula is used, it can be stored as per pixel transforms, which is probably the best approach if it were to be added into our just-in-time composite process, as described below.

If a method is used that relies on categories of hair transformations, then values for each scenario (i.e. blonde to brown) can be stored on the serve, and the source hair images need only be categorized into those classes. If the adjustments for each source file are individually calculated, then the values generated need to be stored with the source file on the server. In either case, the composite alternatives (for hair layers) could be batch processed separately, or the calculations could be done during the just-in-time composite request. The latter is preferable due to the large number of possible combinations.

The following process assumes that they are pre-processed into MGC transformation files, but not applied to the hair layers in all the possible combinations. With the re-colourising steps the modified process can be expressed with the following processing steps in FIG. 1:
A. uncompressing each of the images from each angle and each layer where each image has the same dimensions and correctly relative alignment of the image elements from a format with alpha-channels into a raw 32-bit image data;
B. combining each of the angles of the foreground hair in sequence into a single file storing all the information for its layer (using an approach such as that of the MGC file format described earlier) and storing the resultant file in a database/data structure with a reference number;
C. repeating step A. for the background hair layer and for all the customers mid-ground head layers;
D. when a certain hair style with a certain face model is requested, either:
   (i). requesting the foreground hair, background hair and mid-ground face image MGC files and the reference hair transformation MGC file from the database/data source based on the source to outcome transformation category, or
   (ii). requesting the foreground hair, background hair and mid-ground face image MGC files and the specific hair transformation MGC file from the database/data source;
E. taking the first pixel from the foreground hair layer image file, the first pixel from the head model mid-ground image layer file and the first pixel from the background hair layer image file and combining them and preserving the alpha channel information into the first pixel of the first of the output image series;
F. repeating step E. for all of the pixels of the first frame of the output image series;
G. compressing the resultant image and sending it to the requester or storing the resultant image for compiling into an animated format once all of the frames are complete; and
H. repeating steps E. to G. for all of the frames.

The methods of the invention may involve a few optional features as follows;

The methods may include interpolated frames for rendering a smoother spin. On the client-side often the approximated 3D model is set to rotate on its own, rather than displaying individual frames or having interactive rotation using controls. The model may be modified to include a morph between frames so that when it is spinning the animation can look smoother and provide a higher perceived frame count.

One of the challenges with the system of the invention is that the time taken for users to download files from a website server to their personal computer can be slow with low bandwidth connections. To make the downloads more manageable, the method of the invention may include a user requesting a different number of frames of each hair style depending on the speed of the customer's connection. The size of the returned images, both dimensionally and in terms of compression, can be changed. Rather than changing the speed of the system depending on their bandwidth, the quality and size of the presented images can be changed to suit the internet connection speed. We can also use the same technique to handle different monitor sizes if that is the critical factor for users.

Wherein the foregoing description reference has been made to integers or components having known equivalents then such equivalents are herein incorporated as if individually set forth.

Aspects of the present invention have been described by way of example only and it should be appreciated that modifications and additions may be made thereto without departing from the scope thereof as defined in the appended claims.

1. A method of forming an approximation of a 3-dimensional image of a first object using images obtained of said first object, the method including the steps of;
(i) obtaining a plurality of images of a first object from multiple positions about a substantially horizontal plane;
(ii) creating foreground and background layers of the first object within said image;
(iii) forming a 3-dimensional image of said first object from the images obtained; and
(iv) converting said 3-dimensional image obtained into a desirable format for compositing purposes.

2. The method of forming an approximation of a 3-dimensional image as claimed in claim 2, wherein the first object is a hair style prepared on a model head.

3. The method of forming an approximation of a 3-dimensional image as claimed in claim 2, wherein background layer image content is extrapolated using a reflected copy of an opposed image.

4. The method of forming an approximation of a 3-dimensional image as claimed in claim 2, wherein the creation of foreground and background layers is completed through executing the steps of:
(a) cropping the hair out of each image;
(b) loading the cropped hair images into an alignment process; and
(c) defining foreground and background hair layers within each image.

5. The method of forming an approximation of a 3-dimensional image as claimed in claim 4, wherein said method of creating foreground and background layers includes the following subsequent step of:
(d) animating said plurality of images to identify alignment inconsistencies between images.

6. The method of forming an approximation of a 3-dimensional image as claimed in claim 4, wherein hair layers are defined by following perspective lines in the hair style.

7. The method of forming an approximation of a 3-dimensional image as claimed in claim 4, wherein the hair style to be represented is feathered to obtain a smooth transition between the layers defined.

8. The method of forming an approximation of a 3-dimensional image as claimed in claim 1, wherein an alpha-blending process is is applied to a foreground layer of an image.

9. The method of forming an approximation of a 3-dimensional image as claimed in claim 1, wherein the images converted into a format desirable for compositing are stored in an electronic file format which stores a plurality of sequential images from a common layer within a single file.

10. The method of forming an approximation of a 3-dimensional image as claimed in claim 9, wherein the file format selected stores uncompressed pixel data.

11. The method of forming an approximation of a 3-dimensional image as claimed in claim 9, wherein a file is stored for each layer present in the 3-dimensional image of the first object.

12-17. (canceled)

18. A method of compositing multiple images to form an approximation of a 3-dimensional image, said method being characterized by the execution of the steps of:
a. obtaining a 3-dimensional image of a first object converted into a desirable format;
b. obtaining a 3-dimensional image of a second object, the second object including a face; and
c. combining each of the corresponding pixels of the images of the first and second objects.

19. The method of compositing multiple images as claimed in claim 18, wherein the resulting composite 3-dimensional image is delivered to a remote user using a client software application via a computer network and a server software application.

20. The method of compositing multiple images as claimed in claim 18, wherein the composite 3-dimensional image is generated by a server software application and transmitted to a remote client software application.

21. The method of compositing multiple images as claimed in claim 19, wherein the server software application is adapted to execute the steps of;
a. retrieving a 3-dimensional image of a hair style, and retrieving a 3-dimensional image of a face;
b. taking an initial pixel from the foreground hair layer image, an initial corresponding pixel from a face image and an initial corresponding pixel from a background hair layer image and combining them; and
c. repeating step b. for all subsequent pixels of the corresponding image of the hair style and the corresponding image of the face.

22. The method of compositing multiple images as claimed in claim 21, wherein the server software application is adapted to execute the steps of:
d. compressing the resultant composite image and transmitting it to a user; user; and
e. repeating steps b. to d. for all subsequent images of the hair style and the face.

23. The method of compositing multiple images as claimed in claim 21, wherein the server software application is adapted to execute the further subsequent steps of:
d. storing of the resultant composite image for compilation into an animated format; and
e. repeating steps b. to d. for all subsequent images of the hair style and the face.

24. (canceled)

25. (canceled)
